(19) United States
(12) Patent Application Publication
(10) Pub. No.: US 2024/0142655 A1
(43) Pub. Date: May 2, 2024

(54) SEMI-AIRBORNE ELECTROMAGNETIC-BASED METHOD FOR EXTRACTING SECONDARY FIELD SIGNAL

(71) Applicant: INSTITUTE OF GEOLOGY AND GEOPHYSICS, THE CHINESE ACADEMY OF SCIENCES, BEIJING (CN)

(72) Inventor: PENGFEI LIANG, BEIJING (CN)

(21) Appl. No.: 18/107,981

(22) Filed: Feb. 9, 2023

Related U.S. Application Data
(63) Continuation of application No. PCT/CN2022/128403, filed on Oct. 28, 2022.

(51) Int. Cl. G01V 3/38; G01V 3/165

(52) U.S. Cl. CPC G01V 3/38; G01V 3/165

(57) ABSTRACT

The present disclosure is adapted to the field of geological exploration technology, and provides a semi-airborne electromagnetic-based method for extracting secondary field signal, in which two detection points with different distances from the emission source are provided on the flight route (detection route) during the detection process, and compares the signals detected at the two adjacent detection points to extract the secondary field signal, to better filter out the information generated by the primary electromagnetic field from the extracted field signal, so as to improve the signal quality of the secondary field signal detected by the semi-airborne electromagnetic method, and lay the foundation for high-quality imaging interpretation.

### CROSS-REFERENCE TO RELATED APPLICATIONS

This application is a continuation of co-pending International Patent Application Number PCT/CN2022/128403, filed on Oct. 28, 2022, the disclosure of which is incorporated herein by reference in its entirety.

### TECHNICAL FIELD

The present disclosure relates to the field of geological exploration technology, and more particularly to a semi-airborne electromagnetic-based method for extracting secondary field signal.

### BACKGROUND

According to the semi-airborne electromagnetic method, the emission source is provided on the ground and the detection system is suspended under the aircraft. The magnetic field signal is detected accompanied by the flight of the aircraft. The detected signal includes the primary field signal from the primary electromagnetic field and the secondary field signal from the secondary electromagnetic field. The primary electromagnetic field is mainly related to the emission source, while the secondary electromagnetic field is generated by the conductor based on the eddy current generated from the primary electromagnetic field in the measured area in the stratum, which includes the conductivity information of underground different substances. Since only the secondary electromagnetic field includes the underground conductivity information, generally, only the secondary field signal is retained after removing the primary field signal from the detected electromagnetic signal, which can be used to interpret and speculate the underground conductivity structure.

As shown in FIG. 1, the detection system suspended under the aircraft detects the secondary field signal. Since the energy of the primary electromagnetic field is relatively strong, in a case where the receiving coil (the spherical coil in the middle portion) is operated, the compensating coil (the peripheral annular coil) radiates electromagnetic waves to the outside, which is used to eliminate the primary electromagnetic field. Therefore, the signal received by the receiving coil is considered as the secondary field signal in the existing method.

However, since there is no obvious interval of occurrence time between the primary and the secondary electromagnetic field, which are basically mixed together while being detected, and it is difficult to obtain a secondary field signal while extracting the signal. The inverse interpretation based on the secondary field signal including the primary field signal cannot obtain the accurate underground structure. There are shortcomings in the prior art.

### SUMMARY

A purpose of the present disclosure is to extract secondary field signals from the signals received by the semi-airborne electromagnetic method, and thereby improve the accuracy of the underground structure during the existing inversion interpretation.

The present disclosure provides a semi-airborne electromagnetic-based method for extracting secondary field signal, which includes the following steps:
S1. providing a first detection point and a second detection point on an aircraft route, wherein the distance between the second detection point and an emission source provided on the ground is greater than the distance between the first detection point and the emission source;
S2. detecting an electromagnetic field for one unit duration in a case where the aircraft is flied over the first detection point, and detecting an electromagnetic field for one unit duration in a case where the aircraft is flied over the second detection point;
S3. obtaining a first action sum by normalizing a detected signal detected at the first detection point, and obtaining a second action sum by normalizing a detected signal detected at the second detection point;
S4. obtaining a purified secondary field signal by calculating a difference between the second action sum and the first action sum.

The present disclosure employs two detection points provided on the aircraft route (detection route) at different distances from the emission source during the detection process, and compares the signals detected at the two adjacent detection points to extract the secondary field signal, so as to better filter out the information generated by the primary electromagnetic field from the extracted field signal, so as to improve the signal quality of the semi-airborne electromagnetic method, and lay the foundation for high-quality imaging interpretation.

### BRIEF DESCRIPTION OF DRAWINGS

FIG. 1 is a schematic diagram of semi-airborne electromagnetic method for eliminating the primary field signal in the prior art.

FIG. 2 is a flow chart of an implementation of a semi-airborne electromagnetic-based method for extracting secondary field signal.

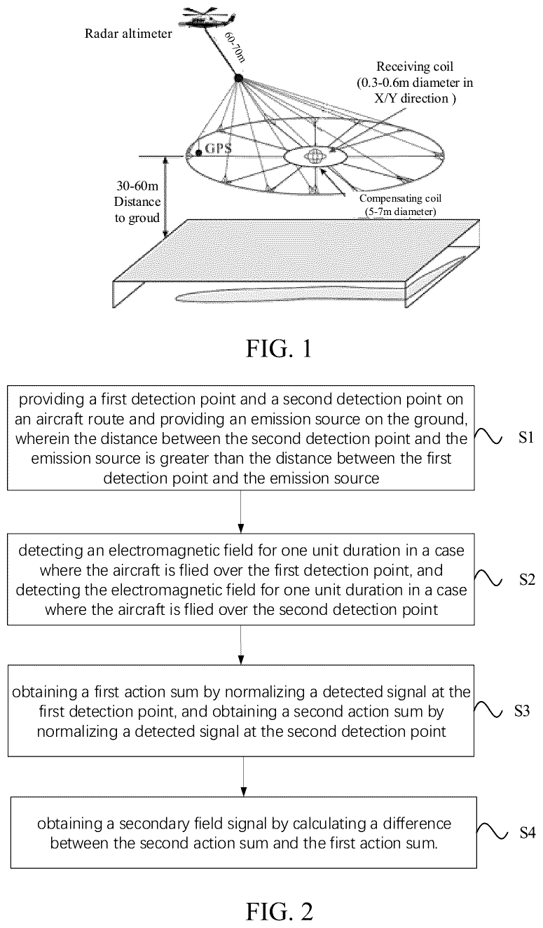

### DETAILED DESCRIPTION OF EMBODIMENTS

In order to make the purpose, technical solutions and advantages of the present disclosure more clearly understood, the present disclosure is further described in detail below in combination with the accompanying drawings and embodiments. It should be understood that the specific embodiments described herein are intended to explain the present disclosure only and are not intended to limit the present disclosure.

The practice of the present disclosure is described in detail below in combination with the specific embodiment:

### EMBODIMENT

FIG. 2 illustrates a practical process of a semi-airborne electromagnetic-based method for extracting secondary field signal provided by the embodiment 1 of the present disclosure, and for ease of illustration, only portions related to the embodiment of the present disclosure are shown, as detailed below:
a semi-airborne electromagnetic-based method for extracting secondary field signal, which includes the following steps:
S1. providing a first detection point and a second detection point on an aircraft route (detection route), wherein the distance between the second detection point and an emission source provided on the ground is greater than the distance between the first detection point and the emission source.

In the specific implementation, the detection of the aircraft along the route is continuously performed, i.e. there are a plurality of detection points on a route. The present disclosure picks out two adjacent detection points of the plurality of detection points as the first detection point and the second detection point, which facilitates the description of the method described in the present disclosure.
S2. detecting an electromagnetic field for one unit duration in a case where the aircraft is flied over the first detection point, and detecting an electromagnetic field for one unit duration in a case where the aircraft is flied over the second detection point.
S3. obtaining a first action sum by normalizing a detected signal detected at the first detection point, and obtaining a second action sum by normalizing the detected signals detected at the second detection point.

In the specific implementation, employing normalization to process the detected signals is helpful to suppress the noise caused by the structure of the instrument itself, the circuitry, etc., and improve the signal-to-noise ratio of the signal.
S4. obtaining a secondary field signal by calculating a difference between the second action sum and the first action sum.

In the specific operation, by changing the detecting method, the secondary field signal calculated from the data is more accurate and purified than by using a compensation coil to eliminate the primary electromagnetic field.

Further, in the step S2, the unit duration is greater than an arrival time of the secondary field signal.

Specifically, the unit duration defined in the present disclosure is a predetermined period of time, and Due to the fast transmission speed of the electromagnetic waves, although the unit duration is relatively short, it can actually still ensure the reception of the electromagnetic waves reflected by the underground medium and transmitted back to the receiving antenna, i.e., the secondary field signal.

Further, in the step S3, the detection signal detected in the first detection point is normalized in the following manner:

$${M}_{1} = \frac{{\int }_{0}^{∞} t * {E}_{1} ( {r}_{1} , t ) dt}{{\int }_{0}^{∞} {E}_{1} ( {r}_{1} , t ) dt} , \qquad ( 1 )$$

Further, the detected signal detected at the second detection point is normalized in the following manner:

$${M}_{2} = \frac{{\int }_{0}^{∞} t * {E}_{2} ( {r}_{2} , t ) dt}{{\int }_{0}^{∞} {E}_{2} ( {r}_{2} , t ) dt} , \qquad ( 2 )$$

wherein, M₁ is the first action sum; M₂ is the second action sum; r₁ is the first detection point; r₂ is the second detection point; t is the unit duration; E₁(r₁, t) is the time domain electromagnetic field signal detected by the receiving coil at the first detection point; E₂(r₂, t) is a time domain electromagnetic field signal detected by the receiving coil at the second detection point.

Further, the first action sum includes the action of the emission source to excite the primary electromagnetic field and the action of stratum to excite the secondary electromagnetic field, wherein the stratum is between the emission source and the first detection point; which is expressed as M₁=Mₛ+Mₛ₁.

In the specific implementation, because the present disclosure is based on the semi-airborne electromagnetic method, the signal frequency is high, and the induction electromagnetic signal generated by the underground medium at further away from the detection points and the emission source quickly decays, which cannot be detected by the instrument equipment generally. Therefore, ignoring such signals, the detection point considered in the present disclosure only detects the induction electromagnetic signal generated by the underground medium under the detection point. A similar assumption is made for the detection of the second detection point.

The second action sum includes the action of the emission source to excite the primary electromagnetic field, the action of stratum between the emission source and the first detection point to excite the secondary electromagnetic field, and the action of stratum between the first detection point and the second detection point to excite the secondary electromagnetic field; which is expressed as M₂=Mₛ+Mₛ₁+M₁₂, wherein, Mₛ is the action of the emission source to excite the primary electromagnetic field; Mₛ₁ is the action of stratum between the emission source and the first detection point exciting the secondary electromagnetic field; M₁₂ is the action of stratum between the first detection point and the second detection point to excite the secondary electromagnetic field.

Based on the composition analysis of the first action sum and the second action sum, it is known that the composition difference between the first action sum and the second action sum is exactly the action of the secondary electromagnetic field excited by the stratum between the two detection points, i.e. the secondary field signal.

Further, the difference between the second action sum and the first action sum in step S4 is expressed as: ΔM=M₂−M₁=M₁₂, where ΔM=M₁₂.

The secondary field signal extracted from the second action sum by the difference calculation does not contain the primary field signal at all in principle, which perfectly avoids the interference of the primary electromagnetic field and the time confusion between the primary electromagnetic field and second electromagnetic field. The signal purity is essentially different compared to the existing compensation method.

Further, the method further includes:
S5. speculating the underground conductivity structure between the first detection point and the second detection point by inversion interpreting of the difference between the second action sum and the first action sum. The interference of the primary electromagnetic field on the secondary field signal of the detected signal can be effectively avoided, and the accuracy of the inversion interpreting information can be effectively improved.

The present disclosure is improved based on the semi-airborne electromagnetic method, in which two detection points with different distances from the emission source are provided on the flight route (detection route) during the detection process, and compares the signals detected at the two adjacent detection points to extract the secondary field signal, to better filter out the information generated by the primary electromagnetic field from the extracted field signal, so as to improve the signal quality of the secondary field signal detected by the semi-airborne electromagnetic method, and lay the foundation for high-quality geological imaging interpretation. The above mentioned is only a practical embodiment of the present disclosure and is not intended to limit the present disclosure. Any modification, equivalent substitution and improvement within the spirit and principles of the present disclosure should be included in the protection scope of the present disclosure.

What is claimed is:

1. A semi-airborne electromagnetic-based method for extracting secondary field signal, comprising the following steps:
S1. providing a first detection point and a second detection point on an aircraft route and providing an emission source on the ground, wherein the distance between the second detection point and the emission source is greater than the distance between the first detection point and the emission source;
S2. detecting an electromagnetic field for one unit duration in a case where the aircraft is flied over the first detection point, and detecting the electromagnetic field for one unit duration in a case where the aircraft is flied over the second detection point;
S3. obtaining a first action sum by normalizing a detected signal at the first detection point, and obtaining a second action sum by normalizing a detected signal at the second detection point; and
S4. obtaining a secondary field signal by calculating a difference between the second action sum and the first action sum.

2. The method, as recited in claim 1, wherein, in step S2, the unit duration is greater than an arrival duration of the secondary field signal.

3. The method, as recited in claim 1, wherein, in step S3, the detected signal at the first detection point is normalized in following manner:
$${M}_{1} = \frac{{\int }_{0}^{∞} t * {E}_{1} ( {r}_{1} , t ) dt}{{\int }_{0}^{∞} {E}_{1} ( {r}_{1} , t ) dt} , \qquad ( 1 )$$
the detected signal measured in the second detection point is normalized in following manner:
$${M}_{2} = \frac{{\int }_{0}^{∞} t * {E}_{2} ( {r}_{2} , t ) dt}{{\int }_{0}^{∞} {E}_{2} ( {r}_{2} , t ) dt} , \qquad ( 2 )$$
wherein M₁ is the first action sum; M₂ is the second action sum; r₁ is the first detection point; r₂ is the second detection point; t is the unit duration; E₁(r₁, t) is a time domain electromagnetic field signal detected by a receiving coil at the first detection point; E₂(r₂, t) is a time domain electromagnetic field signal detected by a receiving coil at the second detection point.

4. The method, as recited in claim 3, wherein the first action sum includes the action of the emission source to excite the primary electromagnetic field and the action of stratum to excite the secondary electromagnetic field, wherein the stratum is between the emission source and the first detection point; and the first action sum is expressed as M₁=Mₛ+Mₛ₁; the second action sum includes the action of the emission source to excite the primary electromagnetic field, the action of the stratum between the emission source and the first detection point to excite the secondary electromagnetic field, and the action of the stratum between the first detection point and the second detection point to excite the secondary electromagnetic field; and the second action sum is expressed as M₂=Mₛ+Mₛ₁+M₁₂; wherein Mₛ is the action of the emission source to excite the primary electromagnetic field; Mₛ₁ is the action of the stratum between the emission source and the first detection point to excite the secondary electromagnetic field, and M₁₂ is the action of the stratum between the first detection point and the second detection point to excite the secondary electromagnetic field.

5. The method, as recited in claim 4, in step S4, the difference between the second action sum and the first action sum is expressed as: ΔM=M₂−M₁=M₁₂; wherein ΔM=M₁₂.

6. The method, as recited in claim 5, further comprising the following steps:
S5. speculating the conductivity structure of underground between the first detection point and the second detection point by inversion interpreting of the difference between the second action sum and the first action sum.
